(19) United States
(12) Patent Application Publication
(10) Pub. No.: US 2021/0345820 A1
(43) Pub. Date: Nov. 11, 2021

(54) COFFEE MAKER

(71) Applicant: LG Electronics Inc., Seoul (KR)

(72) Inventors: Dongseong KWAG, Seoul (KR); Imsung YOO, Seoul (KR)

(21) Appl. No.: 17/231,667

(22) Filed: Apr. 15, 2021

(30) Foreign Application Priority Data
May 8, 2020 (KR) 10-2020-0054947

(51) Int. Cl. A47J 31/46; A47J 31/10; A47J 31/44; B05B 15/68

(52) U.S. Cl. CPC A47J 31/46; A47J 31/10; F16H 19/04; B05B 15/68; A47J 31/4475

(57) ABSTRACT

A coffee maker includes: an extractor that is configured to receive ground coffee and water and that is configured to extract liquid coffee from the ground coffee and the water, and a dispenser configured to supply the water to the ground coffee in the extractor. The dispenser includes an arm that is rotatably disposed above an inlet of the extractor and that includes a nozzle configured to supply the water to the extractor, a first actuator that is disposed at the arm and that is configured to move the nozzle to a position where the nozzle is above the inlet of the extractor, and a second actuator that is disposed at the arm and that is configured to rotate the nozzle to orient the nozzle at a predetermined angle relative to the inlet of the extractor.

### CROSS-REFERENCE TO RELATED APPLICATIONS

Pursuant to 35 U.S.C. § 119(a), this application claims the benefit of the earlier filing date and the right of priority to Korean Patent Application No. 10-2020-0054947, filed on May 8, 2020, in the Korean Intellectual Property Office, which is incorporated herein by reference in its entirety.

### TECHNICAL FIELD

The present disclosure relates to a coffee maker, and relates to a water supply device of the coffee maker.

### BACKGROUND

Recently, many consumers consume coffee by directly brewing coffee at home in various manners. A coffee maker is a device for extracting liquid coffee by supplying water to ground coffee according to a drip or pour-over method among various coffee making methods. Such a coffee maker has been widely used due to a simple and compact structure thereof and a convenient operating method.

The coffee maker includes a container for receiving ground coffee and a dispenser for supplying water to the received ground coffee. However, such a dispenser is generally configured to intensively supply water only to a specific portion of the ground coffee. Therefore, the ground coffee and hot water do not uniformly contact each other, causing difficulties in a high-quality coffee production. The coffee maker may also include a grinder that grinds whole coffee beans and supplies the ground coffee to the container. However, the dispenser, particularly, a nozzle of the dispenser, may be clogged by the supplied ground coffee and may not smoothly supply water.

### SUMMARY

The present disclosure is directed to a coffee maker including a dispenser that is configured to uniformly supply water to ground coffee.

The coffee maker can include a dispenser that limits clogs from ground coffee.

The dispenser, more precisely, a nozzle of the dispenser, can substantially supply water to move with a high degree of freedom. For movement with a high degree of freedom, various mechanical mechanisms are applied to the dispenser. More specifically, the mechanical mechanisms are configured to perform linear displacement and angular displacement of the nozzle. In addition, the mechanical mechanisms of the dispenser simultaneously or individually control such linear displacement and angular displacement of the nozzle. Accordingly, the dispenser can implement motion of the nozzle optimized for coffee extraction by uniformly supplying water to coffee grounds. The dispenser can freely modify motion and trajectory of the nozzle when necessary by the mechanisms of providing a high degree of freedom and thus various recipes for coffee extraction can be implemented. Furthermore, the dispenser can also implement motion of the nozzle that avoids supplied coffee grounds based on a high degree of freedom provided by the mechanical mechanisms.

According to one aspect of the subject matter described in this application, a coffee maker includes an extractor that is configured to receive ground coffee and water and that is configured to extract liquid coffee from the ground coffee and the water, and a dispenser configured to supply the water to the ground coffee in the extractor. The dispenser can include an arm that is rotatably disposed above an inlet of the extractor and that includes a nozzle configured to supply the water to the extractor, a first actuator that is disposed at the arm and that is configured to move the nozzle to a position where the nozzle is above the inlet of the extractor, and a second actuator that is disposed at the arm and that is configured to rotate the nozzle to orient the nozzle at a predetermined angle relative to the inlet of the extractor.

Implementations according to this aspect can include one or more of the following features. For example, the first actuator can include a rack gear that is disposed at the arm and that is coupled to the nozzle, a pinion disposed at the arm and that is configured to move the rack gear, and a first motor configured to rotate the pinion.

In some implementations, the second actuator can include a second motor that is connected to a first end of the arm and that is configured to rotate the arm. In some examples, the arm can include a housing disposed at the first end of the arm, and a rail that extends from the housing and that is configured to support the movement of the nozzle.

In some examples, the rack gear of the first actuator can be arranged along the rail, and the pinion of the first actuator can be rotatably disposed within the housing to engage with the rack gear. In some implementations, a portion of the rack gear of the first actuator can be configured to enter the housing and accommodated within the housing.

In some implementations, the rack gear of the first actuator can be configured to, based on movement of the rack gear, deform and wind within the housing. In some implementations, the housing can include a first guide configured to guide, to the pinion, the rack gear as the rack gear enters the housing, and a second guide configured to guide the rack gear to deform and wind within the housing.

In some examples, the housing can include a roller that is arranged adjacent to the pinion within the housing and that is configured to rotate and push the rack gear toward the pinion based on rotation of the roller. In some implementations, the second actuator can be configured to rotate the first actuator with the arm at a same angle and at a same speed.

In some implementations, the second motor of the second actuator can be connected to the housing and configured to rotate the rail and the nozzle around the housing. In some implementations, the arm can further include a holder that is movably disposed on the rail and that is configured to hold the nozzle.

In some examples, the dispenser can further include a bracket that is coupled to a body of the coffee maker and that is configured to rotatably support the arm. In some examples, the dispenser can further include a member configured to limit a rotation of the arm within a predetermined angle range.

In some implementations, the first and second actuators can be configured to simultaneously rotate and move the nozzle. In some implementations, one of the first and second actuators can be configured to move the nozzle in a first direction, and the other one of the first and second actuators can be configured to move the nozzle in a second direction.

In some implementations, the first and second actuators can be configured to, based on the ground coffee being supplied to the extractor, move the nozzle to an edge of the inlet of the extractor. In some examples, the member can include (i) a slot extending to the bracket in a circumferential direction at a predetermined length and (ii) a connecting rod that is disposed at the housing and that is coupled to the first motor through the slot.

In some examples, a movement of the connecting rod can be limited to the predetermined length of the slot such that the rotation of the arm is limited. In some implementations, the housing can further include at least one component, and the rack gear can be configured to, based on the rack gear moving through the at least on component, deform and wind within the housing.

### BRIEF DESCRIPTION OF THE DRAWINGS

FIG. 1 is a diagram illustrating a schematic view of an exemplary coffee maker.

FIG. 2 is a diagram illustrating a perspective view of a schematic structure of a dispenser of the exemplary coffee maker.

FIG. 3 is a diagram illustrating a perspective view of a detailed structure of the dispenser of the exemplary coffee maker.

FIG. 4 is a diagram illustrating a side view of the dispenser of FIG. 3.

FIG. 5 is a diagram illustrating a sectional view taken along line I-I of FIG. 2.

FIGS. 6 and 7 are diagrams illustrating plan views of an arm and a first actuator of the dispenser.

FIGS. 8, 9, and 10 are diagrams illustrating plan views of various motions of an arm and a nozzle by first and second actuators of the dispenser.

FIGS. 11A to 11C are diagrams illustrating a schematic view of examples of various trajectories of the nozzle of the dispenser.

FIG. 12 is a diagram illustrating a plan view of motions of the arm and the nozzle.

### DETAILED DESCRIPTION

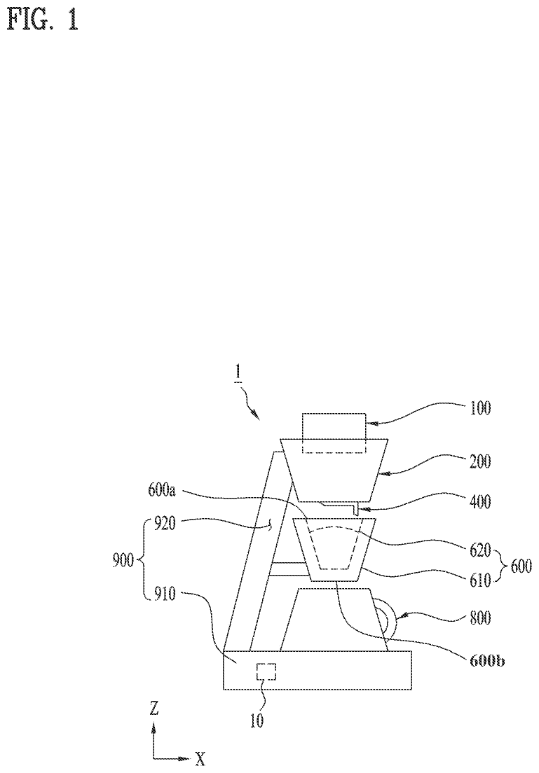

First, the overall configuration of an exemplary coffee maker will be described below with reference to the related drawings. In this regard, FIG. 1 is a diagram illustrating a schematic view of an exemplary coffee maker.

Referring to FIG. 1, a coffee maker 1 can include an extractor 600 that receives supplied hot water and ground coffee and that extracts coffee, i.e., liquid coffee, by bringing the ground coffee into contact with water. The extractor 600 can include a container 610 and a filter 620 accommodated in the container 610. In some implementations, the filter 620 can receive supplied ground coffee, i.e., coffee grounds, and water, and can be configured to pass only extracted liquid coffee. The container 610 can serve to stably support the filter 620. The extractor 600 can include a relatively large inlet 600a for smoothly receiving ground coffee and water and a relatively small outlet 600b which is advantageous for inducing extracted coffee liquid. For example, the extractor 600 can generally have a funnel shape.

In some implementations, the extractor 600 can extract coffee using both a cold brew method and a hot brew method based on a temperature of water used for extraction. If water of a first temperature, which is less than room temperature of 25 degrees Celsius, is used, this may be regarded as the cold brew method and, if water of a second temperature higher than the first temperature is used, this may be regarded as the hot brew method. The extractor 600 can include a first extraction unit configured to use water of the first temperature or a second extraction unit configured to use water of the second temperature, i.e., hot water. The first and second extraction units can be installed in the coffee maker 1 or a user can mount a corresponding extraction unit on the coffee maker 1 according to a desired extraction method.

The coffee maker 1 can include a water supply unit, i.e., a dispenser 400, configured to supply water to the extractor 600. The dispenser 400 can be disposed above the extractor 600, more precisely, above the inlet 600a of the extractor 600, in order to naturally supply water to the extractor 600 by gravity. The dispenser 400 can include a heater that heats water or can receive hot water, i.e., water of the second temperature, from an external water supply source. The dispenser 400 can supply hot water to ground coffee in the extractor 600 using a nozzle. In some implementations, the dispenser 400 can directly supply water of room temperature, i.e., water of the first temperature, to the extractor 600 without any heating.

The coffee maker 1 can include a grinder 200 that grinds whole beans to make ground coffee of a predetermined size or less, i.e., coffee grounds. Since a grinding degree can be different and an extracted degree can also be different according to coffee types, the grinding degree can be differently set in the grinder 200 according to user selection or coffee types. The grinder 200 can also be disposed above the extractor 600 to naturally supply ground coffee to the extractor 600 by gravity. Further, since the grinder 200 has a relatively large size, when the dispenser 400 is disposed above the grinder 200, supply of water may be hindered by the grinder 200. Accordingly, in some implementations, the grinder 200 can be disposed above the dispenser 400 and thus the dispenser 400 can be disposed between the grinder 200 and the extractor 600. By this arrangement, the grinder 200 can first supply ground coffee or coffee grounds to the extractor 600 through the inlet 600a of the extractor 600 opened toward the grinder 200 and then the dispenser 400 can supply water to the previously supplied coffee grounds in the extractor 600 for coffee extraction.

In addition or alternatively, the coffee maker 1 can include a whole bean supplier 100 for supplying whole coffee beans to the grinder 200. The whole bean supplier 100 can be configured to store a sufficient amount of whole beans and supply a predetermined amount of whole beans to the grinder 200 whenever necessary. In some implementations, whole beans can be provided as a disposable whole bean storage capsule that stores only whole beans to be consumed once. If the whole bean storage capsule is disposed in the whole bean supplier 100, the whole bean storage capsule can be automatically opened so that whole beans therein can be discharged to the grinder 200. An identification device containing information about the type of whole beans etc. can be attached to the whole bean storage capsule. The identification device can contain information about the type of whole beans, a roasting degree, and a roasting date. After recognizing the information related to whole beans, the grinder 200 can adjust the grinding degree and the extractor 600 can adjust an extraction time.

The coffee maker 1 can include a server 800 disposed below the extractor 600. The server 800 can be configured to receive and store coffee liquid discharged through the extractor 600, more precisely, the outlet 600b of the extractor 600. In some implementations, the server 800 can be detachably installed in the coffee maker 1 so that the stored coffee can be moved to another place.

The coffee maker 1 can include a body 900 configured to accommodate and support the above-described internal devices 100, 200, 400, 600, and 800. As shown, the body 900 can include a base 910 that rests on the floor and a supporter 920 that is extended upward from the base 910. For example, as shown in FIG. 1, the supplier 100, the grinder 200, the dispenser 400, and the extractor 600 can be mounted directly to the supporter 920 or using other accessories and can be supported by the supporter 920. As described above, the server 800 can be detachably disposed on the base 910 and can be separated from the coffee maker 1 in order to move the stored coffee to another container.

The coffee maker 1 can include a control device 10. The control device 10 can be disposed, for example, in the base 910. The control device 10 can be configured to control all operations of the coffee maker 1 and the devices 100, 200, 400, 600, and 800 of the coffee maker 1. As an example, the control device 10 can include a substrate, and a processor and related electronic components mounted on the substrate and can be electrically connected to the devices 100, 200, 400, 600, 800 of the coffee maker 1. Therefore, the control device 10 can substantially control these elements for an intended operation.

The control device 10, i.e., the processor, can refer to various names such as a controller and a controlling unit and, in particular, can control all elements of the dispenser 400 in order to perform operation of the dispenser 400 to be described later. Accordingly, the control device 10 can substantially control all operations described below and motions performed by the operations. Thereby, all features related to the control operations described below can be all features of the control device 10. For this reason, detailed features of all operations and motions described herein can be understood as features of the control device 10. Alternatively, operations of individual elements performed by the control device 10 can also be regarded as unique features of the corresponding elements.

In the coffee maker 1, the dispenser 400, more precisely, the nozzle of the dispenser 400 that supplies water, can be fixed so as not to move and can be configured to supply water only to a specific point of coffee grounds in the extractor 600. In addition or alternatively, even if the nozzle of the dispenser 400 is configured to be movable, movement of the nozzle can be limited. For this reason, in order to uniformly supply water to coffee grounds in the extractor 600, the coffee maker 1 can include the dispenser 400 configured to freely move the nozzle to desired points. A detailed description of this dispenser 400 will be given in detail below with reference to the related drawings.

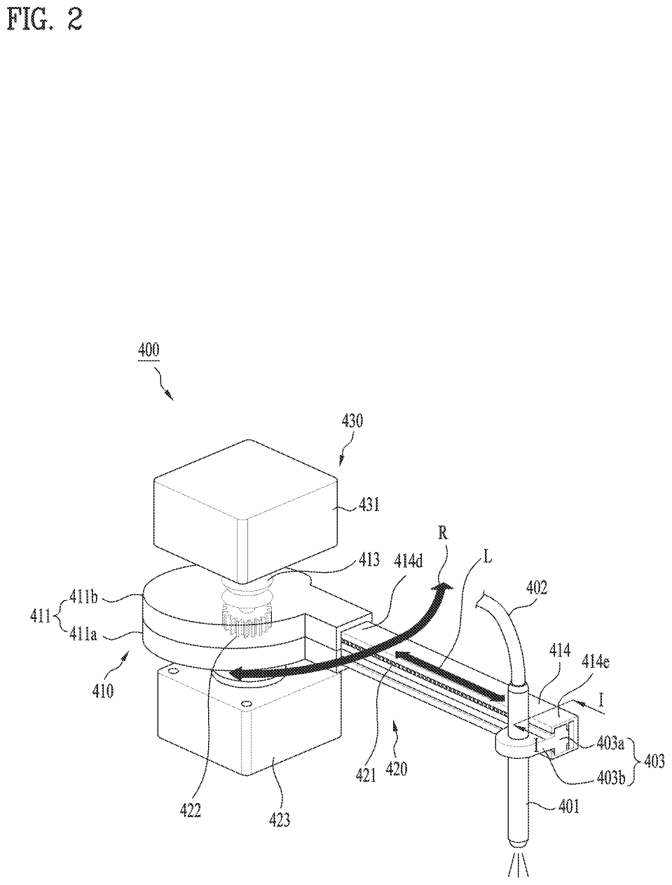

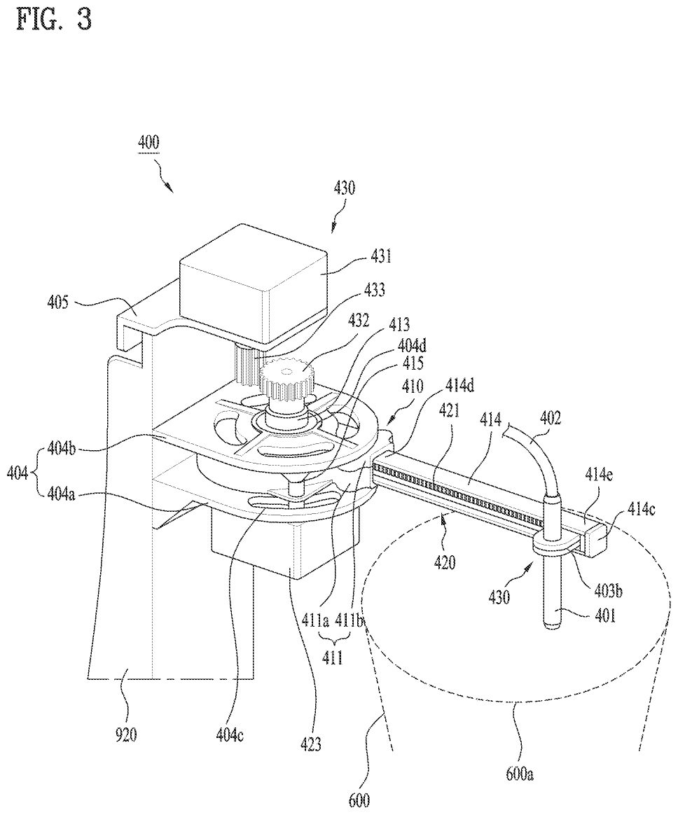

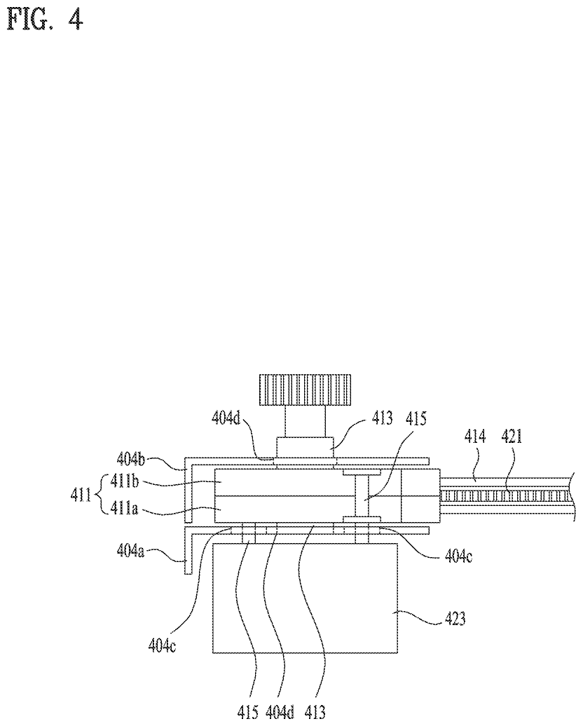

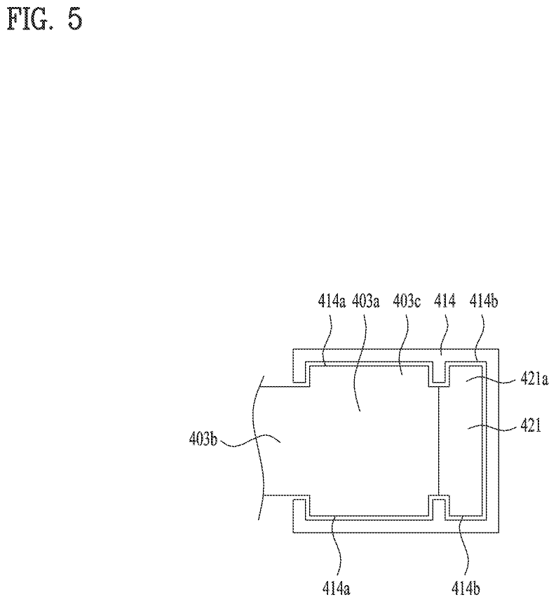

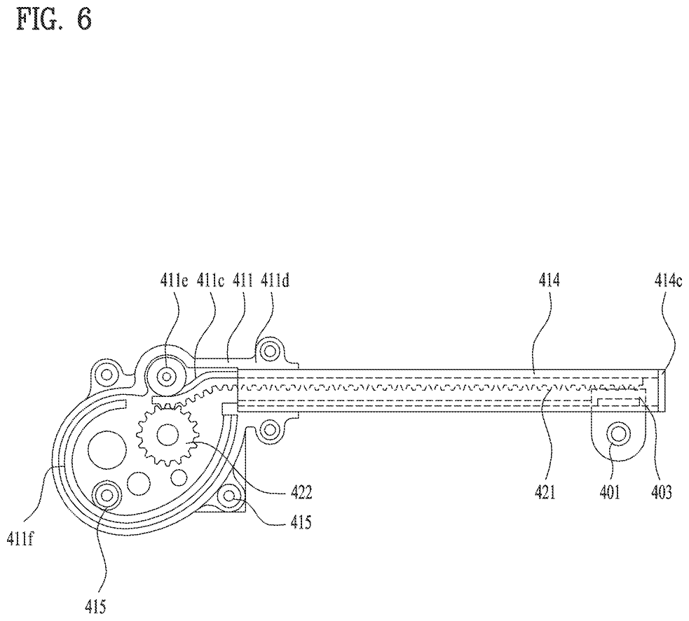

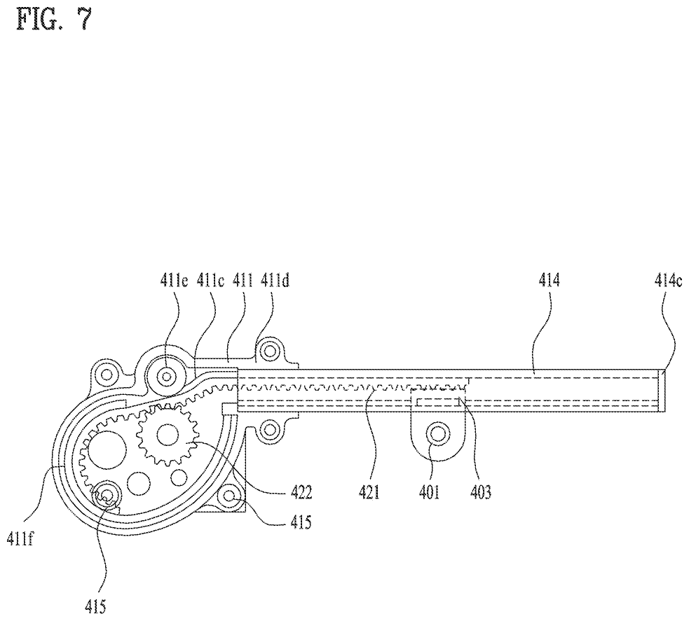

FIG. 2 is a diagram illustrating a perspective view of a schematic structure of a dispenser of the coffee maker 1. FIG. 3 is a diagram illustrating a perspective view of a detailed structure of the dispenser of the coffee maker 1. FIG. 4 is a diagram illustrating a side view of the dispenser of FIG. 3. FIG. 5 is a diagram illustrating a sectional view taken along line I-I of FIG. 2. FIGS. 6 and 7 are diagrams illustrating plan views of an arm and a first actuator of the dispenser. More specifically, FIGS. 6 and 7 illustrate the arm from which an upper housing is eliminated in order to show the interior of a housing. FIG. 6 illustrates a state of the first actuator when a nozzle is arranged far from the housing of the arm and FIG. 7 illustrates a state of the first actuator when the nozzle is moved close to the housing of the arm.

Referring to FIGS. 2 and 3, the dispenser 400 can include an arm 410 that is movably, more precisely, rotatably, disposed above the inlet 600a of the extractor 600. The arm 410 includes a nozzle 401 for supplying water, and a tube 402 connected to a water supply source is connected to the nozzle 401. As shown, the nozzle 401 is oriented downward. Thereby, water supplied through the tube 402 is sprayed from the nozzle 401 onto ground coffee, i.e., coffee grounds, in the extractor 600 below the nozzle 401 by gravity. As will be described in detail below, the arm 410 can hold the nozzle 401 so as not to be detached therefrom and movably support the nozzle 401.

For example, the arm 410 can include a housing 411 disposed at an end portion of the arm 410 and configured to receive various components. The housing 411 can include a lower housing (i.e., a first housing) 411a, and an upper housing (i.e., a second housing) 411b coupled to the lower housing 411a. The lower and upper housings 411a and 411b can form a space for receiving the components therein. In some implementations, the housing 411 can include one member instead of the two separate members 411a and 411b. As will be described below, the arm 410 can be configured to pivot around the housing 411 and be disposed outside the extractor 600, more precisely, disposed outside the inlet 600a of the extractor 600, so as not to block the inlet 600a of the extractor 600 or not to interfere with components of the extractor 600.

The arm 410 can include a rail 414 extended from the housing 411. The rail 414 can be extended above the inlet 600a of the extractor 600 to substantially cross the inlet 600a in a straight line. For example, the rail 414 can include a first end 414d connected to the housing 411 and a second end 414e opposite to the first end 414d. The rail 414 can be configured to movably support the nozzle 401 linearly. The rail 414 can be formed of a channel member including a groove extended in a straight line, and the nozzle 401 can linearly reciprocate along the formed groove of the rail 414. Further, the rail 414 can have an open side portion so that the vertically oriented nozzle 401 can be easily inserted or coupled. In order for the nozzle 401 to linearly move throughout the inlet 600a, the rail 414 can have a distance between two opposite points of the edge of the inlet 600a, e.g., a length corresponding to the diameter of the inlet 600a.

For example, the arm 410 can be movably arranged on the rail 414 and include a holder 403 configured to hold the nozzle 401. The holder 403 can include a base 403a disposed within the rail 414 and configured to move along the rail 414. In some implementations, the holder 403 can include a flange 403b that is horizontally extended from the base 403a to the outside of the rail 414 and that includes a through hole into which the nozzle 401 is inserted. As shown in FIG. 5, the rail 414 can include a recess 414a extended to elongate in a length direction of the rail 414, and the base 403a can include a projection 403c extended from the base 403a and inserted into the recess 414a. In some implementations, the holder 403 and the nozzle 401 coupled thereto can linearly move along the rail in a stable manner by the recess 414a and the projection 403c. The rail 414 can also include a stopper 414c that is disposed at the second end 414e of the rail 414 and that closes the rail 414. In some implementations, the holder 403 and the nozzle 401 may not be separated from the rail 414 by the stopper 414c during linear reciprocating motion.

Referring to FIGS. 3 and 4, for the arm 410 to smoothly pivot, the dispenser 400 can include a bracket 404 coupled to the body of the coffee maker 1, more precisely, the supporter 920 (see FIGS. 1 and 3). The bracket 404 can be configured to rotatably support the arm 410. As described above, since the arm 410 can be configured to pivot around the housing 411 outside the inlet 600a, the bracket 404 can be disposed outside the inlet 600a to support the housing 411. For example, the bracket 404 can include a first bracket 404a disposed below the arm 410 (i.e., the housing 411) and a second bracket 404b disposed above the arm 410. The first and second brackets 404a and 404b can be formed of horizontally extended plate-shaped members and can support the arm 410, more precisely a lower face and an upper face of the housing 411, respectively. For example, the housing 411 can be interposed between the first and second brackets 404a and 404b and can be stably supported to pivot by the first and second brackets 404a and 404b. As shown in FIGS. 3 and 4, each of the first and second brackets 404a and 404b can include a through hole 404d. The housing 411 can include bosses 413 extended from the first and second housings 411a and 411b of the housing 411, more precisely, from lower faces and upper faces of the first and second housings 411a and 411b, and inserted into the through hole 404d. Therefore, the arm 410 can be coupled, by the through hole 404d and the bosses 413, to the bracket 404 so as not to be separated. In some implementations, the arm 410 can pivot around the bosses 413 above the inlet 600a relative to the bracket 404 at a predetermined angle.

Referring to FIGS. 2, 3, 4, 6, and 7, the dispenser 400 can include a first actuator 420 disposed on the arm 410 and configured to linearly move the nozzle 401 to a predetermined distance above the inlet 600a of the extractor 600. For example, the first actuator 420 can enable the nozzle 401 to perform linear motion or linear displacement in a direction of an arrow L (see FIG. 2), which is a length direction of the rail 414.

The first actuator 420 can include a rack gear 421 disposed on the arm 410 and coupled to the nozzle 401. The rack gear 421 can be extended to elongate along the rail 414 of the arm 410 and can be movably disposed along an inner space of the rail 414. As shown in FIG. 5, the rail 414 can include a recess 414b extended to elongate in a length direction of the rail 414, and the rack gear 421 can include a projection 421a extended from the rack gear 421 and inserted into the recess 414b. Accordingly, by the recess 414b and the projection 421a, the rack gear 421 can stably perform linear motion together with the nozzle 401 coupled to the rack gear 421 along the rail 414. The rack gear 421 may not protrude to the outside of the rail 414 by the stopper 414c and may not interfere with other components around the rack gear 421. As illustrated in FIG. 5, the rack gear 421 can be coupled to the holder 403 so as to be coupled to the nozzle 401. For example, the rack gear 421 can be coupled to the base 403a of the holder 403.

The first actuator 420 can also include a pinion 422 disposed on the arm 410 together with the rack gear 421 and configured to linearly reciprocate the rack gear 421. The pinion 422 can be rotatably disposed within the housing 411, as shown in FIGS. 6 and 7, and can be engaged with the rack gear 421. The rack gear 421 can be partially disposed within the housing 411 so as to be engaged with the pinion 422. In some implementations, the first actuator 420 can include a first motor 423 configured to rotate the pinion 422. The first motor 423 can be disposed outside the arm 410, more precisely, below the housing 411, and a drive shaft of the first motor 423 can be coupled to the pinion 422 by penetrating the housing 411. In some implementations, the first motor 423 can be disposed above the housing 411. Therefore, when the pinion 422 rotates by driving of the first motor 423, the rack gear 421 engaged with the pinion 422 can perform linear motion within the rail 414. Thereby, the nozzle 401 coupled to the rack gear 421 can also linearly move along the rail 414 with the holder 403.

In addition, if the first motor 423 is fixed to a component of the coffee maker 1, e.g., the supporter 920 or the bracket 404, rather than the arm 410, the pinion 422 coupled to the first motor 423 can relatively rotate in a direction opposite to a pivoting direction of the arm 410 while the arm 410 pivots. Accordingly, the rack gear 421 may be unintentionally moved by this relative rotation and, accordingly, movement of the nozzle 401 may not be accurately controlled. For this reason, the first motor 423 can be directly coupled to the arm 410, more precisely, the housing 411 of the arm 410, instead of being fixed to other components around the motor 423, i.e., the supporter 920 or the bracket 404. For example, the arm 410 or the housing 411 can include a plurality of connecting rods 415 formed on the housing 411 and vertically extended toward the first motor 423 as shown in FIGS. 3 and 4. The first motor 423 can be coupled to the connecting rods 415 so as to be directly fixed to the arm 410 (or the housing 411). The connecting rods 415 can be formed to avoid the bracket 404 interposed between the first motor 423 and the housing 411. For a simpler structure, the connecting rods 415 can be extended by penetrating the bracket 404. Accordingly, the first motor 423 can pivot at the same angle and speed as a pivoting angle and speed of the arm 410 while the arm 410 pivots. For this reason, since the pinion 422 coupled to the first motor 423 also rotates at the same angle and speed as the pivoting angle and speed of the arm 410, relative rotation is not generated and the rack gear 421 may not move while the arm 410 pivots.

Referring to FIGS. 6 and 7, the rack gear 421 can be formed to be considerably long for linear motion of the nozzle 401 throughout the inlet 600a of the extractor 600 as described above. Therefore, the rack gear 421 extended to be long has a considerably long administrative distance during linear reciprocating motion. For example, the rack gear 421 can have an administrative distance corresponding to twice the length thereof. If the rack gear 421 is made of a material of high rigidity and is not deformed, the rack gear 421 can be moved beyond the arm 410, more precisely, the housing 411, in order to secure a required administrative distance. However, in this case, the rack gear 421 protruding or drawn out of the arm 410 may interfere with other components of the coffee maker 1 and thus may not properly operate. For this reason, the rack gear 421 can be primarily formed of a flexible rack gear made of an elastic material. Since the flexible rack gear 421 can be elastically deformed and restored, even when the rack gear 421 is drawn out of the arm 410 and contacts components around the arm 410, the rack gear 421 can be appropriately deformed and enable movement thereof and movement of the nozzle 401 coupled to the rack gear 421. Nevertheless, this modified rack gear 421 is still likely to interfere with the components around the arm 410. Accordingly, while the entire rack gear 421 linearly moves, the rack gear 421 can be configured to move into the housing 411 and to be accommodated in the housing 411. For example, the entire rack gear 421 can be configured to be arranged within the arm 410 without protruding or being drawn out of the arm 410 (i.e., the housing 411 and/or the rail 414) during linear reciprocating motion. By way of further example, as shown in FIG. 7, even when the nozzle 401 and an end of the rack gear 421 coupled to the nozzle 401 are disposed at the first end 414d of the rail 414 adjacent to the housing 411, the housing 411 can accommodate the rack gear 421 so that the rack gear 421 is not drawn to the outside.

For the housing 411 to accommodate the rack gear 421, the rack gear 421 can be configured to be deformed and wound within the housing 411 while performing linear motion. Accordingly, the rack gear 421 can be entirely accommodated in a limited inner space of the housing 411 by being wound within the housing 411. For example, as shown in FIGS. 6 and 7, for smooth accommodation of the rack gear 421, the housing 411 can include a first guide 411c disposed within the housing 411 and configured to guide the rack gear 412, i.e., a part of the rack gear 412, entering the housing 411 to the pinion 422. The first guide 411c can be disposed adjacent to an inlet 411d of the housing 411 to which the rail 414 (more precisely, the first end 414d of the rail 414) is coupled. The first guide 411c can include a rib oriented to be substantially inclined toward the pinion 422. Accordingly, the rack gear 421 entering the housing 411 can be guided by the first guide 411c and smoothly engaged with the pinion 422. The housing 411 can also include a second guide 411f disposed within the housing 411 and configured to guide the rack gear 421 to be wound within the housing 411. The second guide 411f can be extended to elongate along an inner surface of the housing 411 adjacent to the pinion 422 and guide the rack gear 421 passing through the pinion 422 to be deformed. The second guide 411f can be formed of a curved rib to have a predetermined curvature. The rack gear 421 can be wound within the housing 411 while being deformed according to the shape of the second guide 411f Further, the housing 411 can include a roller 411e that is rotatably installed within the housing 411 and is disposed adjacent to the pinion 422. The roller 411e can be disposed adjacent even to the first guide 411c. Therefore, while rotating, the roller 411e can be configured to enter the housing 411 and push the rack gear 421 guided by the first guide 411c toward the pinion 422. Thereby, the rack gear 421 can be more certainly engaged with the pinion 422. The roller 411e can be configured to feed the rack gear 421 with the pinion 422 to the second guide 411f while rotating, thereby inducing smooth deformation of the rack gear 421.

Referring back to FIGS. 2, 3, 4, 6, and 7, the dispenser 400 can include a second actuator 430 disposed on the arm 410 and configured to pivot the nozzle 401 above the inlet 600a of the extractor 600 at a predetermined angle. For example, the second actuator 430 can enable the nozzle 401 to perform angular motion or angular displacement in a direction of an arrow R.

The second actuator 430 can be connected to any one end of the arm 410 and configured to pivot the arm 410 around the one end. For example, the second actuator 430 can be coupled to the housing 411 disposed at the end of the arm 410 and configured to rotate the rail 414 and the nozzle 401 around the housing 411. As described above, since the housing 411 is disposed outside the inlet 600a of the extractor 600, the second actuator 430 can substantially rotate the arm 410 around a predetermined point outside the inlet 600a of the extractor 600. Since the first motor 423 of the first actuator 420 can be directly coupled to the housing 411 as described above, the second actuator 430 can substantially rotate all components of the first actuator 420 including the first motor 423 and the pinion 422 at the same angle and speed with the arm 410, thereby limiting the pinion 422 from performing unnecessary relative rotation.

To enable the arm 410 to pivot, the second actuator 430 can include a second motor 431 drivably connected to the end of the arm 410, i.e., the housing 411. A drive shaft of the second motor 431 can be coupled to the arm 410 or the housing 411 (more precisely the boss 413 of the arm 410 or the housing 411) as shown in FIG. 2. The second motor 431 can be connected to the housing 411 using a gear train. For example, as shown in FIG. 3, the second actuator 430 can include a gear train including first and second gears 432 and 433 engaged with each other. The first gear 432 can be coupled to the arm 410 or the housing 411, and the second gear 433 can be coupled to the second motor 431. Accordingly, the second actuator 430 can provide sufficient torque to the arm 410 using deceleration by the gear train. The second motor 431 can be disposed above the arm 410 or the housing 411 as shown in FIG. 3 and be coupled to the supporter 920 directly or using an auxiliary bracket 405. In some implementations, the second motor 431 can be directly coupled to the bracket 404. If the arm 410 excessively rotates by the second actuator 330, the arm 410 may interfere with the components around the coffee maker 1. Accordingly, the dispenser 400 may further include a restriction mechanism for rotatably allowing the arm 410 to rotate only within a predetermined angle range. For example, the restriction mechanism can include a slot 404c extended to the bracket 404 in a circumferential direction by a predetermined length and the connecting rod 415 disposed on the housing 411 and coupled to the first motor 423 by penetrating the slot 404c. The slot 404c can be formed to correspond to a demanded pivoting angle. For example, the length of the slot 404c can be formed to be a length that allows an angle required for the arm 410 to pivot between two opposite points of the edge of the inlet 600a of the extractor 600. Accordingly, movement of the connecting rod 415 can be limited to the length of the slot 404c and thus rotation of the housing 411, i.e., the arm 410, connected to the rod 415 can also be restricted.

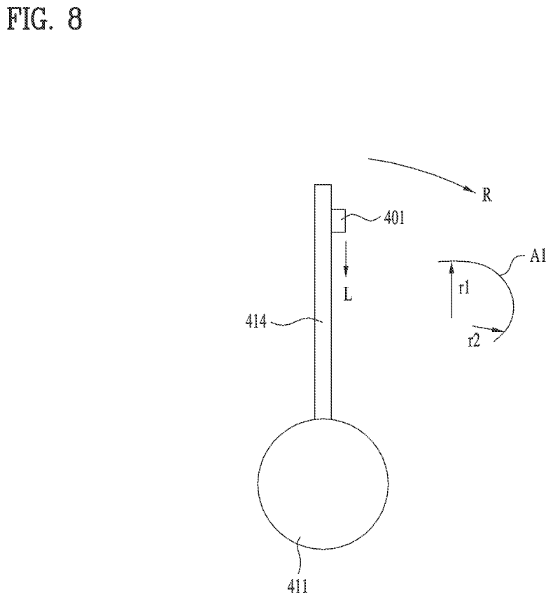

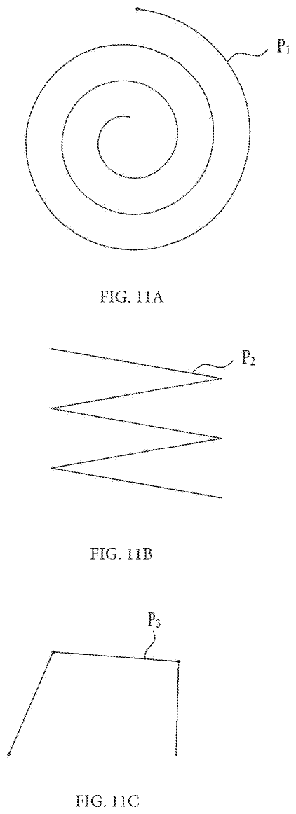

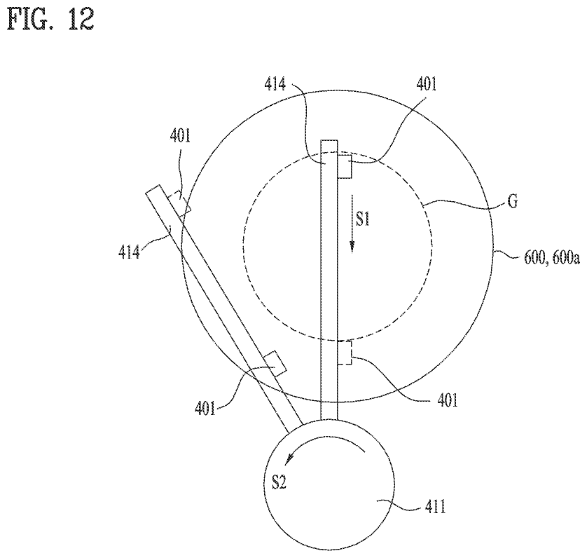

As described above, since the dispenser 400 pivots and linearly moves the nozzle 401 using the first and second actuators 420 and 430, various motions of the nozzle 401 having a high degree of freedom can be implemented. FIGS. 8, 9, and 10 are diagrams illustrating plan views of various motions of the arm and the nozzle by the first and second actuators of the dispenser. FIGS. 11A to 11C are diagrams illustrating a schematic view of examples of various trajectories of the nozzle of the dispenser. FIG. 12 is a diagram illustrating a plan view of motions of the arm and the nozzle. With reference to these drawings, various motions of the nozzle 401 performed by the dispenser 400 and various trajectories of the nozzle 401 will now be described as follows.

First, as shown in FIG. 8, the first and second actuators 420 and 430 can be configured to linearly move the nozzle 401 while pivoting the nozzle 401 at the same time. For example, the nozzle 401 can pivot while continuously performing linear motion. Accordingly, as shown, the nozzle 401 can perform motion A1 having different radii r1 and r2 that are gradually changed, i.e., having different curvatures that are gradually changed. This motion A1 can uniformly cover the entire inlet 600a of the extractor 600. Therefore, if water is continuously sprayed from the nozzle 401 during this motion A1, then ground coffee, i.e., coffee grounds, can evenly contact water supplied from the nozzle 401 and coffee can be effectively and efficiently extracted.

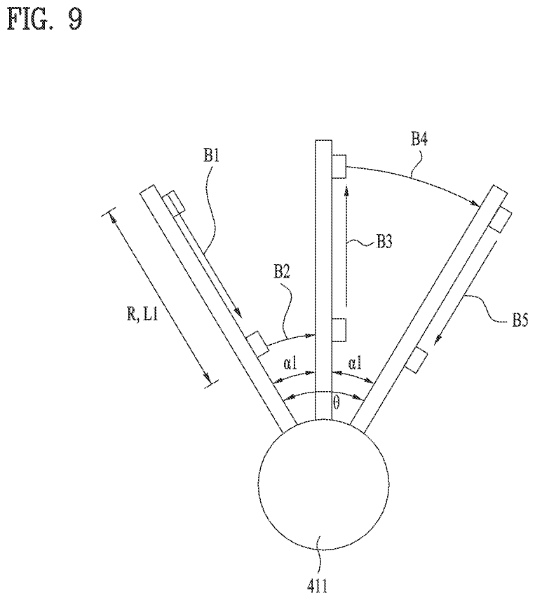

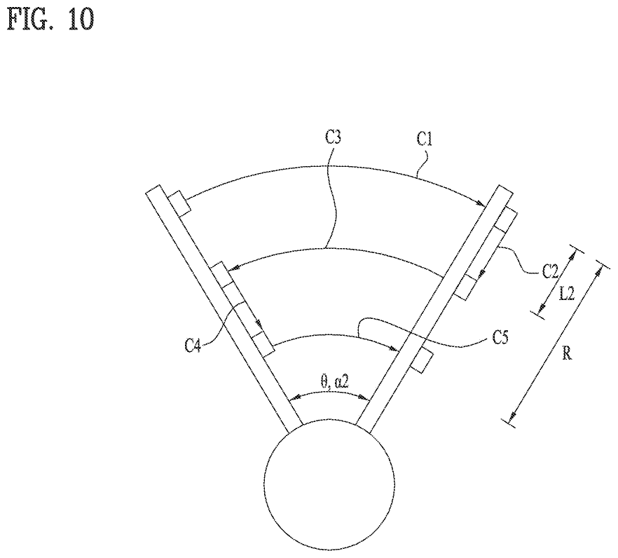

The nozzle 401 can be first moved by any one of the first and second actuators 420 and 430 and then moved by the other one of the first and second actuators 420 and 430. For example, motions by the first and second actuators 420 and 430 can be sequentially performed. For example, referring to FIG. 9, the nozzle 401 can first be linearly moved to a predetermined distance L1 by the first actuator 420 (motion B1) and then be pivoted at a predetermined angle α1 by the second actuator 430 (motion B2). By way of further example, the predetermined distance L1 can correspond to an administrative distance R of a maximum linear motion of the first actuator 420, whereas the predetermined angle α1 can correspond to an angle smaller than a maximum pivoting angle θ of the second actuator 430. After these motions B1 and B2, the nozzle 401 can repeat similar motions B3, B4 and B5, as shown. In some implementations, referring to FIG. 10, the nozzle 401 can first be pivoted at a predetermined angle α2 by the second actuator 430 (motion C1), and then be linearly moved to a predetermined distance L2 by the first actuator 420 (motion C2). For example, the predetermined distance L2 can be smaller than the administrative distance R of the maximum linear motion of the first actuator 420, whereas the predetermined angle α2 can correspond to the maximum pivoting angle θ of the second actuator 430. After these motions C1 and C2, the nozzle 401 can repeat similar motions C3, C4, and C5, as shown. These motions B1 to B5 and C1 to C5 can uniformly cover the entire inlet 600a of the extractor 600. Therefore, when water is continuously sprayed from the nozzle 401 during these motions B1 to B5 and C1 to C5, ground coffee, i.e., coffee grounds, can evenly contact water supplied from the nozzle 401 and coffee can be effectively and efficiently extracted.

By the motions according to FIGS. 8, 9, and 10, the nozzle 401 can form various trajectories P1 to P3 as shown in FIGS. 11A-C. For example, as shown in FIG. 11A, the nozzle 401 can form a spiral trajectory P1. Since the spiral trajectory P1 requires a radius of curvature and a curvature that are continuously changed, this trajectory P1 can be formed by the motion A1 as shown in FIG. 8. In addition, as shown in FIG. 11B, the nozzle 401 can form a zigzag-shaped trajectory P2. This trajectory P2 can be formed by the motions B1 to B5 and C1 to C5 as shown in FIGS. 9 and 10. These trajectories P1 and P2 substantially correspond to trajectories used when water is supplied to coffee grounds in the extractor 600 and enable efficient coffee extraction. Furthermore, as shown in FIG. 11C, the nozzle 401 can form a trajectory P3 moving to an arbitrary position. This trajectory P3 can be achieved by appropriately performing operations of the first and second actuators 420 and 430 simultaneously or individually. The trajectory P3 is advantageous in constructing various recipes for coffee extraction by supplying water to portions intended by the user.

As shown in FIG. 12, when coffee grounds are supplied to the extractor 600 manually by the user or automatically by the grinder 200, the coffee grounds generally pass through a central region G of a predetermined size disposed in the inlet 600a of the extractor 600. Therefore, if the nozzle 401 is disposed in the central region G, the coffee grounds may be accumulated on the nozzle 401 and may clog the nozzle 401. Therefore, while the coffee grounds are supplied to the extractor 600, the dispenser 400, i.e., the actuators 420 and 430 of the dispenser 400, can move the nozzle 401 out of the region G. For example, the first actuator 420 can move the nozzle 401 to a region adjacent to the housing 411, i.e., above the edge of the inlet 600a, as indicated by an arrow S1. In addition, if the coffee grounds are stacked even on the rail 414, movement of the nozzle 401 may be disturbed. Accordingly, as indicated by an arrow S2, the second actuator 430 can pivot the rail 414 above the edge of the inlet 600a so as to leave the region G. For example, the rail 414 can be oriented along the edge of the inlet 600a and can avoid being contacted by the coffee grounds. By such pivoting, not only the rail 414 but also the nozzle 401 can be disposed above the edge of the inlet 600a so as to leave the region G. Therefore, the coffee grounds can be blocked from being stacked on the nozzle 401 and the rail 414, and smooth operation of the dispenser 400 can be ensured.

The effects of the coffee maker 1 are as follows.

In the coffee maker 1, the dispenser can include first and second actuators each independently performing linear displace and angular displacement of the nozzle. The dispenser can implement various motions of the nozzle having a high degree of freedom using these first and second actuators. Accordingly, the nozzle can move along a trajectory uniformly passing through all of coffee grounds in the coffee maker and water sprayed from the nozzle can uniformly contact the coffee grounds. Accordingly, high-quality coffee can be efficiently and effectively extracted. Since the nozzle can also move along various trajectories according to user's intention, recipes for coffee extraction desired by the user can be implemented. For this reason, the coffee maker can have improved coffee extraction capability and expanded functionality.

Furthermore, the nozzle can be moved to avoid being contacted by supplied coffee grounds according to operations of the first and second actuators. Therefore, the nozzle can be limited from being clogged by the coffee grounds so that the reliability and stability of the coffee maker can be further improved.

What is claimed is:

1. A coffee maker, comprising:
an extractor that is configured to receive ground coffee and water and that is configured to extract liquid coffee from the ground coffee and the water; and
a dispenser configured to supply the water to the ground coffee in the extractor,
wherein the dispenser includes:
an arm that is rotatably disposed above an inlet of the extractor and that includes a nozzle configured to supply the water to the extractor;
a first actuator that is disposed at the arm and that is configured to move the nozzle to a position where the nozzle is above the inlet of the extractor; and
a second actuator that is disposed at the arm and that is configured to rotate the nozzle to orient the nozzle at a predetermined angle relative to the inlet of the extractor.

2. The coffee maker of claim 1, wherein the first actuator includes:
a rack gear that is disposed at the arm and that is coupled to the nozzle;
a pinion disposed at the arm and that is configured to move the rack gear; and
a first motor configured to rotate the pinion.

3. The coffee maker of claim 2,
wherein the second actuator includes a second motor that is connected to a first end of the arm and that is configured to rotate the arm.

4. The coffee maker of claim 3, wherein the arm includes:
a housing disposed at the first end of the arm; and
a rail that extends from the housing and that is configured to support the movement of the nozzle.

5. The coffee maker of claim 4,
wherein the rack gear of the first actuator is arranged along the rail, and the pinion of the first actuator is rotatably disposed within the housing to engage with the rack gear.

6. The coffee maker of claim 5,
wherein a portion of the rack gear of the first actuator is configured to enter the housing and accommodated within the housing.

7. The coffee maker of claim 6,
wherein the rack gear of the first actuator is configured to, based on movement of the rack gear, deform and wind within the housing.

8. The coffee maker of claim 6, wherein the housing includes:
a first guide configured to guide, to the pinion, the rack gear as the rack gear enters the housing; and
a second guide configured to guide the rack gear to deform and wind within the housing.

9. The coffee maker of claim 6,
wherein the housing includes a roller that is arranged adjacent to the pinion within the housing and that is configured to rotate and push the rack gear toward the pinion based on rotation of the roller.

10. The coffee maker of claim 4,
wherein the second actuator is configured to rotate the first actuator with the arm at a same angle and at a same speed.

11. The coffee maker of claim 4,
wherein the second motor of the second actuator is connected to the housing and configured to rotate the rail and the nozzle around the housing.

12. The coffee maker of claim 4,
wherein the arm further includes a holder that is movably disposed on the rail and that is configured to hold the nozzle.

13. The coffee maker of claim 4,
wherein the dispenser further includes a bracket that is coupled to a body of the coffee maker and that is configured to rotatably support the arm.

14. The coffee maker of claim 13,
wherein the dispenser further includes a member configured to limit a rotation of the arm within a predetermined angle range.

15. The coffee maker of claim 1,
wherein the first and second actuators are configured to simultaneously rotate and move the nozzle.

16. The coffee maker of claim 1,
wherein one of the first and second actuators is configured to move the nozzle in a first direction, and the other one of the first and second actuators is configured to move the nozzle in a second direction.

17. The coffee maker of claim 1,
wherein the first and second actuators are configured to, based on the ground coffee being supplied to the extractor, move the nozzle to an edge of the inlet of the extractor.

18. The coffee maker of claim 14,
wherein the member includes (i) a slot extending to the bracket in a circumferential direction at a predetermined length and (ii) a connecting rod that is disposed at the housing and that is coupled to the first motor through the slot.

19. The coffee maker of claim 18,
wherein a movement of the connecting rod is limited to the predetermined length of the slot such that the rotation of the arm is limited.

20. The coffee maker of claim 7,
wherein the housing further includes at least one component, and the rack gear is configured to, based on the rack gear moving through the at least on component, deform and wind within the housing.
